(19) United States
(12) Patent Application Publication
(10) Pub. No.: US 2014/0095771 A1
(43) Pub. Date: Apr. 3, 2014

(54) HOST DEVICE, COMPUTING SYSTEM AND METHOD FOR FLUSHING A CACHE

(71) Applicant: SAMSUNG ELECTRONICS CO., LTD., SUWON-SI (KR)

(72) Inventors: CHANG-MAN LEE, SEOUL (KR); JAE-GEUK KIM, HWASEONG-SI (KR); CHUL LEE, HWASEONG-SI (KR); JOO-YOUNG HWANG, SUWON-SI (KR)

(73) Assignee: SAMSUNG ELECTRONICS CO., LTD., SUWON-SI (KR)

(21) Appl. No.: 14/038,989

(22) Filed: Sep. 27, 2013

(30) Foreign Application Priority Data
Sep. 28, 2012 (KR) 10-2012-0109192

(51) Int. Cl. G06F 12/08

(52) U.S. Cl. CPC G06F 12/0817; G06F 12/0891
USPC 711/103; 711/135

(57) ABSTRACT

A computing system includes a storage device, and a host device configured to flush a plurality of pages to the storage device. The host device includes a write-back (WB) cache configured to store the pages, and a file system module configured to flush pages having first characteristics to the storage device from among the pages stored in the WB cache, and then flush pages having second characteristics which are different from the first characteristics to the storage device from among the pages stored in the WB cache.

A claim of priority is made to Korean Patent Application No. 10-2012-0109192 filed on Sep. 28, 2012, in the Korean Intellectual Property Office, the disclosure of which is incorporated herein by reference in its entirety.

### BACKGROUND

The inventive concept presented herein relates to computing systems and to data management methods of computing systems, and in particular, to techniques for flushing a cache memory to a storage device.

When a file system writes a file to a storage device, both file data and metadata are stored in the storage device. The file data includes the content of the file that a user application intends to store. On the other hand, metadata includes non-content data, such as attributes of the file and a position of a block in which the file data is stored.

In an actual operation, the file system may first may store the file data and the metadata in a cache, and then, at some later point in time, execute a cache flush in which the file data and the metadata are transferred from the cache to the storage device.

### SUMMARY

According to an aspect of the present inventive concept, a computing system is provided which includes a storage device, and a host device configured to flush a plurality of pages to the storage device. The host device includes a write-back (WB) cache configured to store the pages, and a file system configured to flush pages having first characteristics to the storage device from among the pages stored in the WB cache, and then flush pages having second characteristics which are different from the first characteristics to the storage device from among the pages stored in the WB cache.

According to another aspect of the present inventive concept, a host device is provided which includes a storage interface configured to communicate with a storage device, a write-back (WB) cache memory configured to store a plurality of pages, and a file system module configured to flush pages having first characteristics to the storage device via the storage interface from among the plurality of pages stored in the WB cache, and then flush pages having second characteristics which are different from the first characteristics to the storage device via the storage interface among the plurality of pages.

According to yet another aspect of the present inventive concept, a method of managing data in a computing system is provided which includes providing a plurality of pages, and flushing N pages to a storage device from among the pages, where N is a natural number. The flushing of the N pages to the storage device includes flushing the N pages having first characteristics to the storage device when the number of pages having the first characteristics from among the pages is M, where M is a natural number, and M≧N, and flushing L pages having the first characteristics to the storage device when the number of pages having the first characteristics from among the pages is L, and then flushing P pages having second characteristics which are different from the first characteristics to the storage device, wherein L and P are natural numbers, L<N, and P=N−L.

### BRIEF DESCRIPTION OF THE DRAWINGS

The above and other aspects and features of the present inventive concept will become apparent from the detailed description that follows, with reference to the accompanying drawings, in which:

FIG. 1 is a block diagram of a computing system according to an embodiment of the present inventive concept;

FIG. 2 is a block diagram showing an example of a host device shown in FIG. 1;

FIG. 3 is a diagram depicting an example of a logical module hierarchy of the host device shown in FIG. 1;

FIG. 4 is a diagram illustrating an example of the configuration of a storage area of a storage device shown in FIG. 1;

FIG. 5 is a diagram illustrating an example of the configuration of data stored in the storage device of FIG. 1;

FIG. 6A is a diagram illustrating an example of the structure of a file stored in the storage device of FIG. 1;

FIG. 6B is a diagram illustrating an example of the structure of a directory stored in the storage device of FIG. 1;

FIGS. 7A, 7B, 7C and 7D are diagrams illustrating example of the arrangement of blocks stored in the storage device of FIG. 1;

FIG. 8 is a diagram illustrating an example of a node address table (NAT);

FIGS. 9A and 9B are diagrams for reference in describing an example of a process of updating data stored in the storage device of FIG. 1;

FIG. 10 is a flowchart for reference in describing a method of managing data in a computing system according to an embodiment of the present inventive concept;

FIGS. 11, 12 and 13 are diagrams for reference in describing an example of the data management method referenced in FIG. 10;

FIG. 14 is a block diagram illustrating an example of a computing system adopting one or more embodiments of the present inventive concept; and

FIGS. 15, 16 and 17 are block diagrams illustrating other examples of computing system adopting one or more embodiments of the present inventive concept.

### DETAILED DESCRIPTION OF THE EMBODIMENTS

Advantages and features of the present inventive concept and methods of accomplishing the same may be understood more readily by reference to the following detailed description of preferred embodiments and the accompanying drawings. The present inventive concept may, however, be embodied in many different forms and should not be construed as being limited to the embodiments set forth herein. Rather, these embodiments are provided so that this disclosure will be thorough and complete and will fully convey the concept of the inventive concept to those skilled in the art, and the present inventive concept will only be defined by the appended claims. In the drawings, the relative dimensions may be exaggerated for clarity.

It will be understood that when an element or layer is referred to as being “on” or “connected to” another element or layer, it can be directly on or connected to the other element or layer or intervening elements or layers may be present. In contrast, when an element is referred to as being “directly on” or “directly connected to” another element or layer, there are no intervening elements or layers present. Like numbers refer to like elements throughout. As used herein, the term “and/or” includes any and all combinations of one or more of the associated listed items.

The use of the terms “a” and “an” and “the” and similar referents in the context of describing the inventive concept (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted.

It will be understood that, although the terms first, second, etc. may be used herein to describe various elements, these elements should not be limited by these terms. These terms are only used to distinguish one element from another element. Thus, for example, a first element, a first component or a first section discussed below could be termed a second element, a second component or a second section without departing from the teachings of the present inventive concept.

Unless defined otherwise, all technical and scientific terms used herein have the same meaning as commonly understood by one of ordinary skill in the art to which this inventive concept belongs. It is noted that the use of any and all examples, or exemplary terms provided herein is intended merely to better illuminate the inventive concept and is not a limitation on the scope of the inventive concept unless otherwise specified. Further, unless defined otherwise, all terms defined in generally used dictionaries may not be overly interpreted.

As is traditional in the field of the present inventive concept, embodiments are at least partially described/depicted herein in terms of functional blocks and/or units and/or modules. Unless otherwise stated, it will be understood that these blocks/units/modules may be physically implemented by hard-wired electronic circuits and/or logic circuits, or by processor driven software, or any by a combination thereof. Non-limiting examples include Field Programmable Gate Array (FPGA) or Application Specific Integrated Circuit (ASIC), which performs certain tasks. The blocks/units/module may be configured to reside on the addressable storage medium and configured to execute responsive to one or more processors. Each block/unit/module may, by way of example, be made up of a combination of components, such as software components, object-oriented software components, class components and task components, processes, functions, attributes, procedures, subroutines, segments of program code, drivers, firmware, microcode, circuitry, data, databases, data structures, tables, arrays, and variables. Also, it will be understood that each of the blocks/units/modules described herein may be physically and/or functionally divided into multiple blocks and/or units without departing from the inventive concept. Conversely, two or more blocks and/or units described herein may be physically and/or functionally combined into a single block and/or unit without departing from the inventive concept.

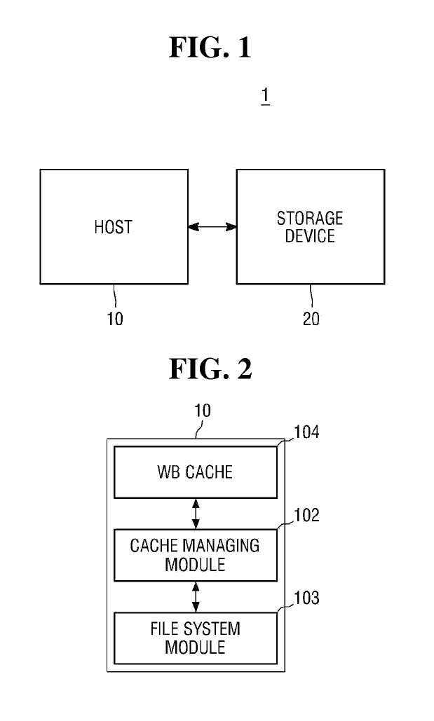

FIG. 1 is a block diagram of a computing system 1 according to an embodiment of the present inventive concept.

Referring to FIG. 1, the computing system 1 according to the current embodiment includes a host device 10 and a storage device 20.

The host device 10 and the storage device 20 exchange data with each other via respective host and storage interfaces, and in accordance with a predetermined interface protocol. As examples, the host device 10 and the storage device 20 may communicate with each other in accordance one or more of a universal serial bus (USB) protocol, a multimedia card (MMC) protocol, a peripheral component interconnection (PCI) protocol, a PCI-express (PCI-E) protocol, an advanced technology attachment (ATA) protocol, a serial-ATA protocol, a parallel-ATA protocol, a small computer small interface (SCSI) protocol, an enhanced small disk interface (ESDI) protocol, and an integrated drive electronics (IDE) protocol. However, the present inventive concept is not limited by the communication protocol(s) between the host device 10 and the storage device 20.

The storage device 20 is operationally controlled by host device 10. For example, the host device 10 may control the writing of data to the storage device 20 and/or the reading of data from the storage device 20.

The storage device 20 is not limited by type. Examples include a data server, a card storage device, a static solid disk (SSD), a hard disk drive (HDD), a MultiMediaCard (MMC), an eMMC, and so on.

FIG. 2 is a block diagram showing an example of the host device 10 shown in FIG. 1.

Referring to FIG. 2, the host device 10 may include a write-back (WB) cache 104 which is used to write data to the storage device 20, a cache managing module 102 which manages the WB cache 104, and a file system module 103.

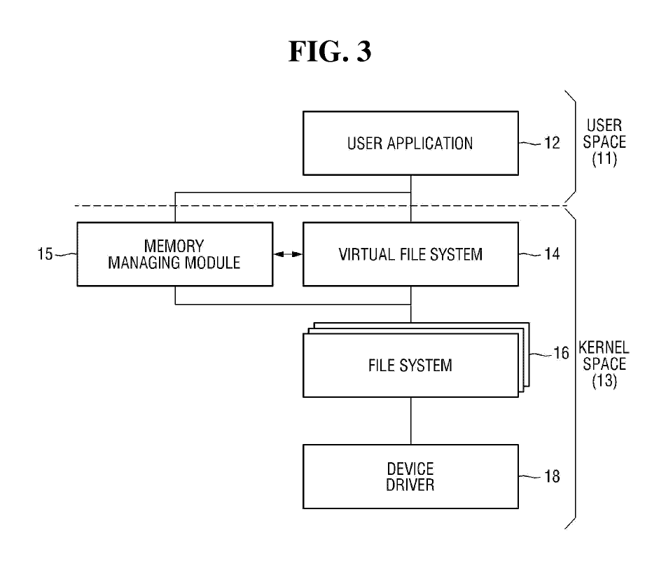

The WB cache 104 may be configured to store plural pages of data. As mentioned previously, a general file system may first may store file data and metadata in a cache, and then, at some later point in time, execute a cache flush in which the file data and the metadata are transferred from the cache to the storage device. Depending on its attributes, the metadata to be flushed to the storage device may include metadata which is updated frequently and metadata which is updated relatively less frequently. This can result in unnecessary write operations since outdated metadata may be flushed to the storage device. With this in mind, in some embodiments herein, the pages stored in the WB cache 104 may include first pages which are to be flushed to the storage device 20, and second pages which do not need to be flushed to the storage device 20. These second pages in the WB cache 104 may be those that have been updated, for example, by a user application 12 (see FIG. 3) before being flushed.

The cache managing module 102 may manage each of the pages stored in the WB cache 104. For example, the cache managing module 102 may utilize dirty flags to manage the pages stored in the WB cache 104 as the above-described first and second pages. In this case, the cache managing module 102 may set a dirty flag for the first pages which are to be flushed to the storage device 20 from among the pages stored in the WB cache 104 and may not set the dirty flag for the second pages which do not need to be flushed to the storage device 20.

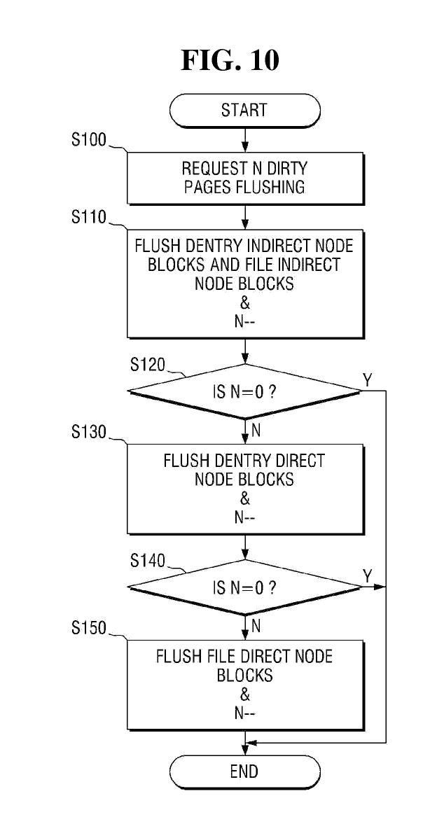

The file system module 103 operates according to a given protocol to flush first pages of the WB cache 104 to the storage device 20. For example, in an embodiment, when the proportion of first pages (i.e., pages set with a dirty flag) among the total number of the pages stored in the WB cache 104 is a predetermined value or greater, the file system module 103 may flush the first pages to the storage device 20. In another embodiment, the file system module 103 may flush first pages having first characteristics to the storage device 20 from among a plurality of first pages stored in the WB cache 104, and then flush first pages having second characteristics, which are different from the first characteristics, to the storage device 20. The detailed operation of the file system module 103 will be described later with reference to FIGS. 10 through 13.

An example of host device 10 will now be described in greater detail with reference to logical module hierarchy shown in FIG. 3.

Referring to FIG. 3, the host device 10 generally includes a user space 11 and a kernel space 13.

The user space 11 is an area in which a user application 12 is executed, and the kernel space 13 is an area dedicated to execution of a kernel. The user space 11 may access the kernel space 13 using a system call provided by the kernel.

The kernel space 13 may include a virtual file system 14 which connects an I/O call of the user space 11 to an appropriate file system 16, a memory managing module 15 which manages a memory of the host device 10, one or more file systems 16, and a device drive driver 18 which provides a hardware control call for controlling the storage device 20.

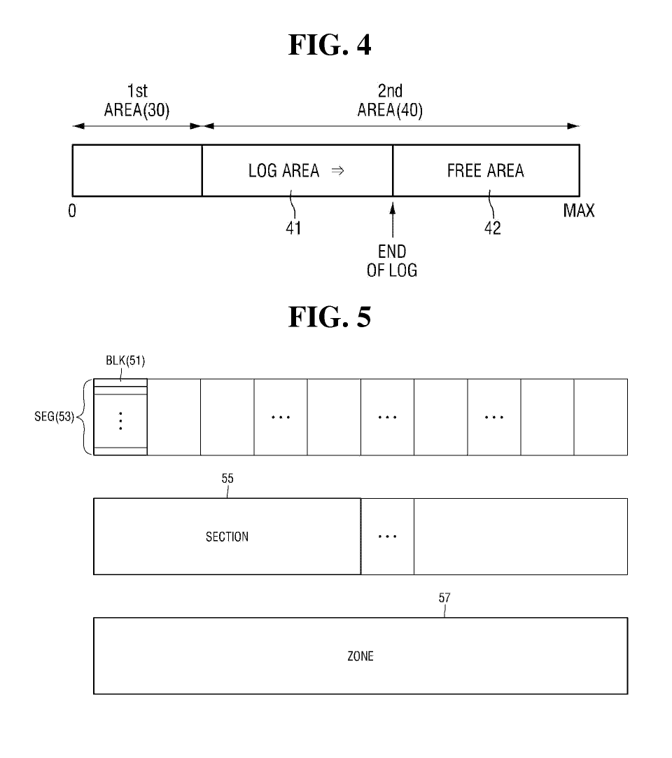

The file systems 16 are not limited by type, and a few examples thereof include ext2, ntfs, smbfs, and proc. In an example embodiment which will be described later with reference to FIGS. 4 through 9B, one or more of the file systems 16 is a Flash-Friendly-File-System (F2FS) which is based on a log-structured file system.

The virtual file system 14 enables the file systems 16 to operate with each other. For a read/write operation on different file systems 16 of different media, the virtual file system 14 enables the use of a standardized system call. For example, the system call such as open( ) read( ) or write( ) can be used regardless of the type of the file systems 16. That is, the virtual file system 14 is a virtual layer existing between the user space 11 and the file systems 16.

The device driver 18 serves as an interface between hardware and a user application (or operating system). The device driver 18 is a program provided for hardware to operate normally on a certain operating system.

In an example embodiment, the cache managing module 102 shown in FIG. 2 may be a sub module included in the virtual file system 14 or the memory managing module 15 shown in FIG. 3. Also, as mentioned above, in an example embodiment, the file system module 103 shown in FIG. 2 may operate as an F2FS file system.

The manner in which the F2FS file system controls the storage device 20 will now be described with reference to FIGS. 4 through 9B.

FIG. 4 is a diagram illustrating an example of the configuration of a storage area of the storage device 20 shown in FIG. 1.

Referring to FIG. 4, the storage device 20 may include a first area 30 and a second area 40. The first area 30 may be an area that is written in a random access manner, and the second area 40 may be an area that is written in a sequential access manner.

A sequential access write operation refers to an operation of sequentially writing data to blocks whose physical addresses in the storage device 20 increase sequentially, and a random access write operation refers to an operation of writing data to blocks having designated physical addresses regardless of the order of the physical addresses.

The F2FS file system may divide the storage device 20 into the first area 30 and the second area 40 when formatting the storage device 20. However, the present inventive concept is not limited thereto. The first area 30 is an area in which various information (such as the number of currently allocated files, the number of effective pages, positions, etc.) managed by the entire system is stored. The second area 40 is a space in which various directory information, data, and file information actually used by a user are stored.

The storage device 20 may include a buffer utilized for random access. For optimum utilization of the buffer, the first area 30 may be stored in a front part of the storage device 20, and the second area 40 may be stored in a rear part of the storage device 20. Here, the front part precedes the rear part in terms of physical address.

If the storage device 20 is, for example, an SSD, a buffer may be included in the SSD. The buffer may be, for example, a single layer cell (SLC) memory that can be read or written at high speed. This allows the buffer to increase the speed of a random access write operation in a limited space. Hence, by placing the first area 30 in the front part of the storage device 20 using the buffer, a reduction in the I/O speed of the storage device 20 due to random access can be avoided.

The second area 40 may consist of a log area 41 and a free area 42. In FIG. 4, the log area 41 is one continuous area. However, as victim segments included in the log area 41 become included in the free area 42 in a segment cleaning process, the log area 41 may become non-continuous.

The log area 41 is an area to which data has already been written, and the free area 42 is an area to which data can be written. Since the second area 40 is written in a sequential access manner, data may be written to the free area 42 located at the end of the log area 41.

When data stored in the log area 41 is modified, the modified data is written not to a position of the stored data in the log area 41 but to the free area 42 located at the end of the log area 41. Here, the stored data becomes invalid.

FIG. 5 is a diagram illustrating an example of the configuration of data stored in the storage device 20 of FIG. 1.

A segment 53 may include a plurality of blocks 51, a section 55 may include a plurality of segments 53, and a zone 57 may include a plurality of sections 55. For example, a block 51 may be 4 Kbytes, and a segment 53 including 512 blocks 51 may be 2 Mbytes. This configuration may be determined at a time when the storage device 20 is formatted. However, the present inventive concept is not limited thereto. The size of each section 55 and the size of each zone 57 can be modified when the storage device 20 is formatted. In this example, the F2FS file system can read/write all data on a 4 Kbyte page-by-4 Kbyte page basis. That is, one page may be stored in each block 51, and a plurality of pages may be stored in each segment 53.

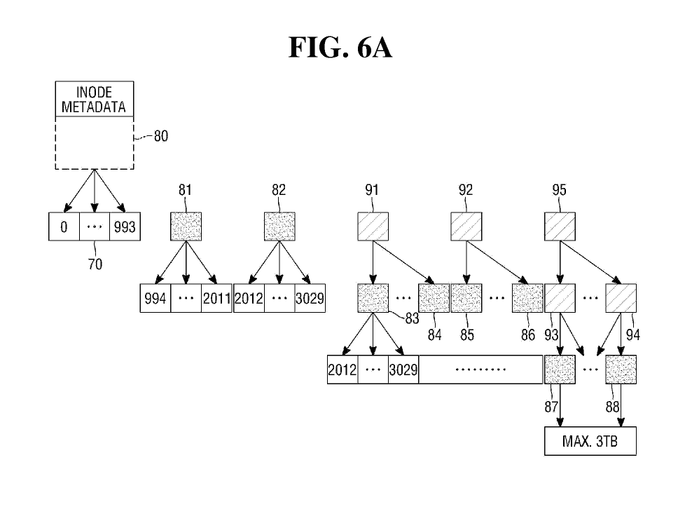

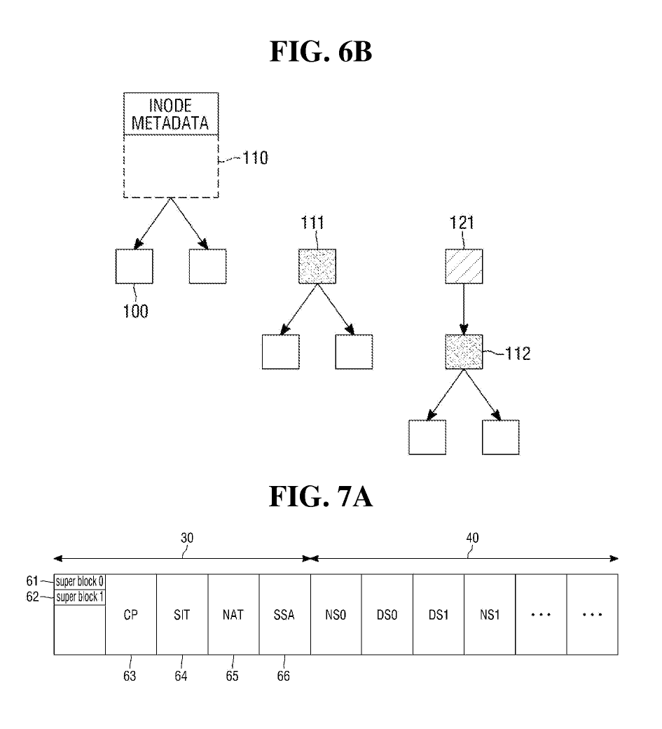

A file stored in the storage device 20 may have an indexing structure as shown in FIG. 6A.

FIG. 6A is a diagram illustrating an example of the structure of a file stored in the storage device 20 of FIG. 1.

One file may consist of file data and metadata about the file data. Data blocks 70 are where the file data is stored, and node blocks 80, 81 through 88 and 91 through 95 are where the metadata is stored.

The node blocks 80, 81 through 88 and 91 through 95 may include file direct node blocks 81 through 88, file indirect node blocks 91 through 95, and a file Mode block 80. In the F2FS file system, one file has one file Mode block 80.

Each of the file direct node blocks 81 through 88 includes an ID of the file Mode block 80 and a number of data pointers (which directly indicate the data blocks 70) equal to the number of the data blocks 70 which are child nodes of the file direct node block. Each of the file direct node blocks 81 through 88 further stores information about where each data block 70 comes in the file corresponding to the file Mode block 80, that is, offset information of each data block 70.

Each of the file indirect node blocks 91 through 95 includes pointers which indicate the file direct node blocks 81 through 88 or other file indirect node blocks 91 through 95. The file indirect node blocks 91 through 95 may include, for example, first file indirect node blocks 91 through 94 and a second file indirect node block 95. The first file indirect node blocks 91 through 94 include first node pointers which indicate the file direct node blocks 83 through 88. The second file indirect node block 95 includes second node pointers which indicate the first file indirect node blocks 93 and 94.

The file Mode block 80 may include at least one of data pointers, first node pointers which indicate the file direct node blocks 81 and 82, second node pointers which indicate the first file indirect node blocks 91 and 92, and a third node pointer which indicates the second file indirect node block 95.

In the example of this embodiment, one file may have a maximum of 3 Tbytes, and such a high-volume file may have the following indexing structure. For example, the file Mode block 80 may have 994 data pointers, and the 994 data pointers may indicate 994 data blocks 70, respectively. In addition, the file Mode block 80 may have two first node pointers, and the two first node pointers may indicate the two file direct node blocks 81 and 82, respectively. The file Mode block 80 may have two second node pointers, and the two second node pointers may indicate the two first file indirect node blocks 91 and 92, respectively. The file Mode bock 80 may have one third node pointer, and the third node pointer may indicate the second file indirect node block 95.

A directory stored in the storage device 20 may have an indexing structure as shown in FIG. 6B.

FIG. 6B is a diagram illustrating an example of the structure of a directory stored in the storage device 20 of FIG. 1.

One directory may include a plurality of file lists and a plurality of nodes associated with the file lists. File blocks 100 are where information about the file lists is stored, and node blocks 110, 111 and 112, and 121 are where metadata about the file blocks 100 is stored.

The node blocks 110, 111 and 112, and 121 may include dentry direct node blocks 111 and 112, a dentry indirect node block 121, and a dentry Mode block 110. In the F2FS file system, one directory has one dentry Mode block 110. The relationship between the dentry direct node blocks 111 and 112, the dentry indirect node block 121 and the dentry Mode block 110 is the same as the relationship between the file direct node blocks 81 through 88, the file indirect node blocks 91 through 95 and the file Mode block 80. Thus, a detailed description thereof is omitted here to avoid redundancy.

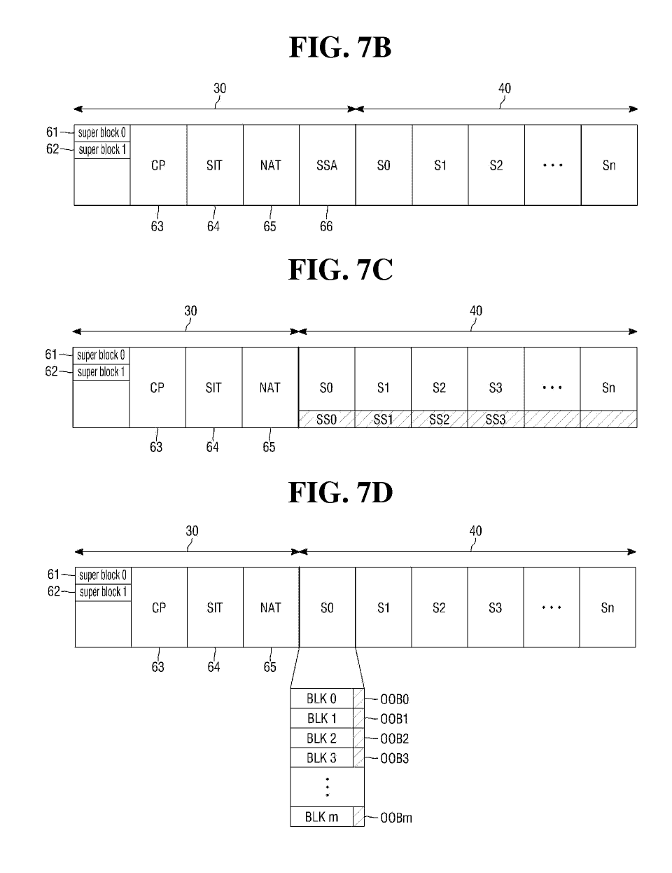

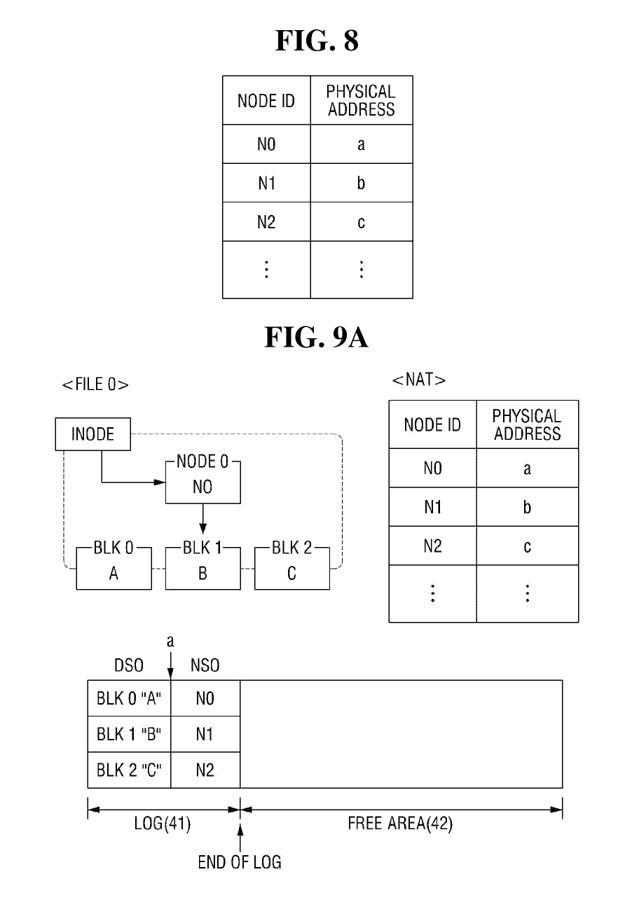

FIGS. 7A through 7D are diagrams illustrating examples of the arrangement of blocks stored in the storage device 20 of FIG. 1. FIG. 8 is a diagram illustrating an example of a node address table (NAT).

FIGS. 7A through 7D illustrate in detail the storage area of the storage device 20 configured by the F2FS file system according to some embodiments of the present inventive concept.

According to an embodiment, the F2FS file system may configure the storage area of the storage device 20 to include a random accessible first area 30 and a sequentially accessible second area 40, as shown in FIG. 7A.

Specifically, the first area 30 may include super blocks 61 and 62, a checkpoint (CP) area 63, a segment information table (SIT) 64, a NAT 65, and a segment summary area (SSA) 66.

In the super blocks 61 and 62, default information of a file system 16 is stored. For example, the size of the blocks 51, the number of the blocks 51, and a status flag (clean, stable, active, logging, unknown) of the file system 16 may be stored. As shown in the drawing, two super blocks 61 and 62 may be provided, and the same content may be stored in the two super blocks 61 and 62. Therefore, when a problem occurs in any of the two super blocks 61 and 62, the other can be used.

The CP area 63 stores a checkpoint. The CP is a logical break point, and the status until the break point is completely preserved. When an accident (e.g., a shutdown) occurs during the operation of a computing system, the file system 16 can recover data using the preserved CP. The CP may be generated periodically, at an Umount time, or at a system shutdown time. However, the present inventive concept is not limited thereto.

Referring to FIG. 8, the NAT 65 may include a plurality of node IDs respectively corresponding to nodes and a plurality of physical addresses respectively corresponding to the node IDs. For example, a node block corresponding to node ID N0 may correspond to physical address a, a node block corresponding to node ID N1 may correspond to physical address b, and a node block corresponding to node ID N2 may correspond to physical address c. All nodes (an Mode, direct nodes, indirect nodes, etc.) have unique node IDs. In other words, all nodes (an Mode, direct nodes, indirect nodes, etc.) may be allocated unique node IDs from the NAT 65. The NAT 65 may store a node ID of an Mode, node IDs of direct nodes, node IDs of indirect nodes, and the like. A physical address corresponding to each node ID can be updated.

The SIT 64 includes the number of live blocks included in each segment and a bitmap indicating whether each block is a live block. Each bit of the bitmap indicates whether a corresponding block is a live block. The SIT 64 can be used in a segment cleaning operation. That is, the file system module 103 can identify live blocks included in each victim segment by referring to the bitmap included in the SIT 64.

The SSA 66 describes an ID of a parent node to which each block included in each segment of the second area 40 belongs.

Each of the file direct node blocks 81 through 88 has address information of the data blocks 70 in order to access the data blocks 70 which are its child blocks. On the other hand, each of the file indirect node blocks 91 through 95 has an ID list of its child nodes in order to access the child node blocks. Once an ID of a certain node block is identified, a physical address thereof can be identified with reference to the NAT 65.

In a log-structured file system, data written to a data block is not overwritten at its original storage position as a different value. Instead, a new data block having the updated data is written at the end of a log. In this case, a parent node block of the data block should modify the existing address of the data block. Therefore, to overwrite a data block or write back the data block at the end of the log in a segment cleaning process, information about a parent node of the data block is required. However, it is difficult for each data block or each node block to identify information about its parent node. Therefore, the F2FS file system according to the present embodiment includes the SSA 66 which contains an index used by each data block or each node block to identify an ID of its parent node block. Based on the SSA 66, the ID of the parent node block of each data block or each node block can be easily identified.

One segment summary block has information about one segment in the second area 40. In addition, the segment summary block consists of a plurality of pieces of summary information, and one piece of summary information corresponds to one data block or one node block.

Referring to FIG. 7A, the second area 40 may include data segments DS0 and DS1 and node segments NS0 and NS1 separate from the data segments DS0 and DS1. A plurality of data may be stored in the data segments DS0 and DS1, and a plurality of nodes may be stored in the node segments NS0 and NS1. If data and nodes are stored in different segments, segments can be managed efficiently, and the data can be read more effectively in a shorter time.

In the drawing, the first area 30 includes the super blocks 61 and 62, the CP area 63, the SIT 64, the NAT 65, and the SSA 66 arranged sequentially. However, the present inventive concept is not limited thereto. For example, the position of the SIT 64 and the position of the NAT 65 can be reversed, and the position of the NAT 65 and the position of the SSA 66 can be reversed.

The F2FS file system can also configure the storage area of the storage device 20 as shown in FIG. 7B. Referring to FIG. 7B, in a storage device of a computing system according to another embodiment of the present inventive concept, the second area 40 may include a plurality of segments S1 through Sn which are separate from each other, where n is a natural number. While data segments and node segments are managed separately in FIG. 7A, data and nodes can be stored together in each of the segments S1 through Sn in FIG. 7B.

The F2FS file system can also configure the storage area of the storage device 20 as shown in FIG. 7C. Referring to FIG. 7C, the first area 30 does not include the SSA 66 (see FIG. 7A). That is, the first area 30 includes the super blocks 61 and 62, the CP area 62, the SIT 64, and the NAT 65. Therefore, segment summary information may be stored in the second area 40. Specifically, the second area 40 includes a plurality of segments S0 through Sn, and each of the segments S0 through Sn is divided into a plurality of blocks. The segment summary information may be stored in at least one block SS0 through SSn of each of the segments S0 through Sn.

The F2FS file system can also configure the storage area of the storage device 20 as shown in FIG. 7D. Referring to FIG. 7D, as in FIG. 7C, the first area 30 does not include the SSA 66 (see FIG. 7A). That is, the first area 30 includes the super blocks 61 and 62, the CP area 62, the SIT 64, and the NAT 65. Therefore, the segment summary information may be stored in the second area 40. The second area 40 includes a plurality of segments S0 through Sn. Each of the segments S0 through Sn is divided into a plurality of blocks BLK0 through BLKm, and the blocks BLK0 through BLKm respectively include out of band (OOB) areas OOB0 through OOBm, where m is a natural number. The segment summary information may be stored in the OOB areas OOB0 through OOBm.

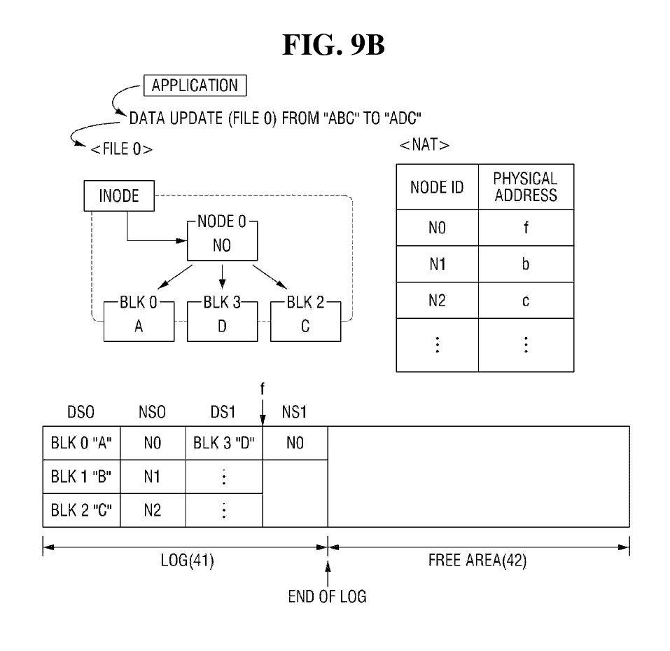

A data update operation of the F2FS file system according to the current embodiment will now be described with reference to FIGS. 9A and 9B.

FIGS. 9A and 9B are diagrams for reference in describing an example of a process of updating data stored in the storage device 20 of FIG. 1.

FIG. 9A illustrates data “ABC” stored in file 0 before being updated, and FIG. 9B illustrates data “ADC” stored in file 0 in response to a command from an application to update the data “ABC” to “ADC.”

The F2FS file system configures file 0 to include node and data blocks as shown in FIG. 6A. For ease of description, it is assumed in FIGS. 9A and 9B that file 0 is configured to include a file Mode which indicates one file direct node N0, and the file direct node N0 which indicates three data blocks.

Referring to FIG. 9A, a first data segment DS0 in a log area 41 includes first through third data blocks BLK 0 through BLK 2. It is assumed that the first data block BLK 0 stores ‘A,’ that the second data block BLK 1 stores “B,” and that the third data block BLK 2 stores “C.” However, this is merely for ease of description. In some other embodiments of the present inventive concept, unlike the illustration in FIG. 9A, the first data segment DS0 may include more data blocks in addition to the first through third data blocks BLK 0 through BLK 2.

A first node segment NS0 in the log area 41 may include the file direct node block N0. The file direct node block N0 may store a node ID (N0) and physical address information of the first through third data blocks BLK 0 through BLK 2. As shown in FIG. 9A, a physical address of the file direct node block N0 is “a.” Meanwhile, a NAT may store N0 which is the ID of the file direct node block and “a” which is the physical address of N0.

File 0 having the updated data may be configured as shown in the example of FIG. 9B.

Referring to FIG. 9B, since the application has instructed to update “ABC” of file 0 to “ADC,” the second data block BLK 1 which stores “B” should be updated. However, the F2FS file system does not update “B” stored in the second data block BLK 1 to “D.” Instead, the F2FS file system stores a new fourth data block BLK 3 which stores “D” in a second data segment DS1 located at the end of the log area 41. That is, the updated file 0 consists of the first data block BLK 0, the fourth data block BLK 3, and the third data block BLK 2. Accordingly, the physical address information of the second data block BLK 1 in the file direct node block N0 should be updated to physical address information of the fourth data block BLK 3. However, the F2FS file system does not update the existing physical address information of the child blocks of the node N0. Instead, the F2FS file system generates a new node block having the physical address information of the first data block BLK 0, the fourth data block BLK 3, and the third data block BLK 2 as address information of its child blocks. Here, the new node block has the same node ID as the node N0. The new node block may be included in a second node segment NS1 located at the end of the log area 41.

The physical address of the node block N0 is changed from “a” to “f.” According to a conventional log-structured file system, if the new node block is generated as described above, the physical address information of the node block N0 included in a file indirect node which is a parent node of the node block N0 should be modified. In addition, since the file indirect node will also be written to a new node block, a node block update operation may continuously propagate to the file Mode as a parent node block. This is called a “wandering tree” problem. Since the wandering tree problem causes excessive nodes to be newly written unnecessarily, it can reduce a write efficiency achieved by sequential access write.

On the other hand, when a file direct node block has to be newly written due to a data block update, the F2FS file system according to the present embodiment simply modifies a physical address (from “a” to “f”) corresponding to the file direct node in the NAT 65. Thus, the node block update operation does not propagate to above the file direct node. Consequently, the F2FS file system solves the wandering tree problem that may occur in the conventional log-structured file system.

A method of managing data in a computer system according to an embodiment of the present inventive concept will now be described with reference to FIGS. 10 through 13.

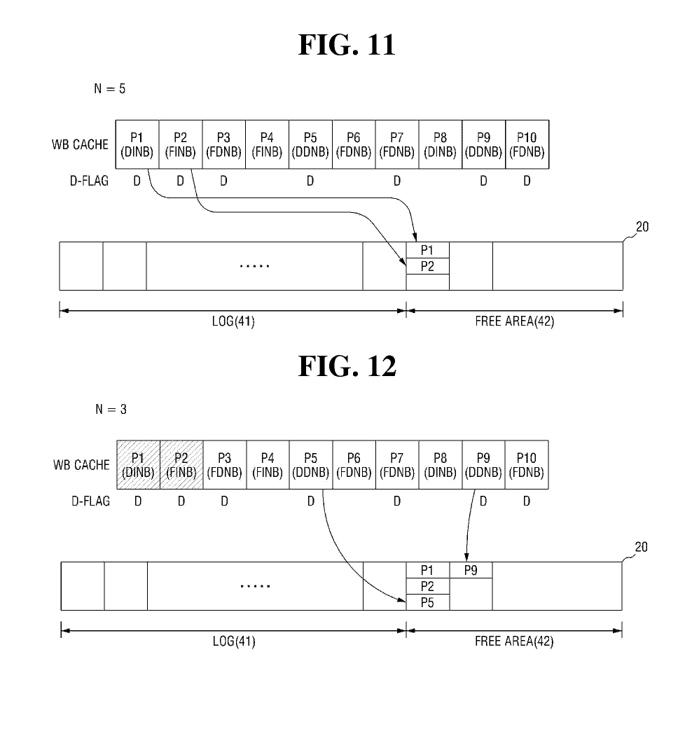

FIG. 10 is a flowchart for reference in describing a method of managing data in a computing system according to an embodiment of the present inventive concept. FIGS. 11 through 13 are diagrams for further describing examples of the data management method of FIG. 10.

Referring to FIG. 10, a request to flush N (N is a natural number) dirty pages is made (operation S100). Specifically, in an example, when the proportion or number of pages set with a dirty flag among a total number of pages stored in a WB cache 104 (see FIG. 2) is a predetermined value or greater, a file system module 103 (see FIG. 2) may make a request to flush N pages set with the dirty flag to a storage device 20 (see FIG. 2).

For ease of description, it is assumed in the example that follows that first through tenth pages P1 through P10 are stored in the WB cache 104, and that a request to flush five pages set with the dirty flag to the storage device 20 (see FIG. 1) was made. Consistent with the example, FIG. 11 shows ten pages P1 through P10 stored in the WB cache 104. However, the example of ten pages is merely for ease of description, and inventive concept is not limited by the number of pages stored in the WB cache 104.

In some embodiments of the present inventive concept, the first through tenth pages P1 through P10 stored in the WB cache 104 may be metadata about a file or a directory. That is, in some embodiments of the present inventive concept, the file system module 103 (see FIG. 2) may flush file data, which is the content of a file that a user application 12 (see FIG. 3) intends to store, and metadata about the file or a directory separately to the storage device 20. In FIG. 11, a case where the metadata about the file or the directory is flushed to the storage device 20 is illustrated.

However, the present inventive concept is not limited to this case. In some other embodiments of the present inventive concept, the file system module 103 (see FIG. 2) can also flush together the file data, which is the content of the file that the user application 12 (see FIG. 3) intends to store, and the metadata about the file or the directory to the storage device 20. In this case, unlike the illustration in FIG. 11, the file data and the metadata may be stored together (not separately) in the WB cache 104.

Referring to FIG. 11, the first through third pages P1 through P3, the fifth page P5, the seventh page P7, and the ninth and tenth pages P9 and 10 are dirty pages set with the dirty flag (D). Therefore, they constitute pages that should be flushed to the storage device 20 at this point in time. On the other hand, the fourth page P4, the sixth page P6 and the eighth page P8 are not set with the dirty flag. Therefore, they constitute pages that do not need to be flushed to the storage device 20 at this point in time. As described previously, the fourth page P4, the sixth page P6 and the eighth page P8 are not set with the dirty flag because these are pages that were updated before the time of flushing.

The first page P1 and the eighth page P8 are pages to be stored in the storage device 20 as dentry indirect node blocks 121 (see FIG. 6B), the fifth page P5 and the ninth page P9 are pages to be stored in the storage device 20 as dentry direct node blocks 111 and 112 (see FIG. 6B), the second page P2 and the fourth page P4 are pages to be stored in the storage device 20 as file indirect node blocks 91 through 95 (see FIG. 6A), and the third page P3, the sixth page P6, the seventh page P7 and the tenth page P10 are pages to be stored in the storage device 20 as file direct node blocks 81 through 88 (see FIG. 6A).

Referring to FIG. 10, pages to be stored in a storage device 20 as file indirect node blocks which index a file and dentry indirect node blocks which index a directory are flushed to the storage device (operation S110).

In the above example, the file system module 103 (see FIG. 2) may flush the first page P1 and the second page P2 to a free area 42 of the storage device 20 as shown in FIG. 11. Here, although the fourth page P4 and the eighth page P8 are pages to be stored in the storage device 20 as a file indirect node block (one of 91 through 95) (see FIG. 6A) and a dentry indirect node block 121 (see FIG. 6B), respectively, they are not flushed to the storage device 20 because they are not dirty pages.

Referring to FIG. 10, after operation S110, it is checked whether all of the N requested pages have been flushed (operation S120). In the above example, although the file system module 103 (see FIG. 2) made a request to flush five pages, only two pages P1 and P2 were flushed to the storage device 20 in operation S110. Therefore, a next operation is performed.

Referring to FIG. 10, pages to be stored in the storage device as dentry direct node blocks which index the directory are flushed to the storage device (operation S130).

In the above example, the file system module 103 (see FIG. 2) may flush the fifth page P5 and the ninth page P9 to the free area 42 of the storage device 20 as shown in FIG. 12. Here, since the free area 42 of the storage device 20 is an area that is written in a sequential access manner, the fifth page P5 and the ninth page P9 may be flushed to blocks having physical addresses which increase sequentially.

Referring to FIG. 10, after operation S130, it is checked whether all of the N requested pages have been flushed (operation S140). In the above example, although the file system module 103 (see FIG. 2) made a request to flush five pages, only four pages P1, P2, P5 and P9 have been flushed to the storage device until operation S130. Therefore, a next operation is performed.

Referring to FIG. 10, pages to be stored in the storage device as file direct node blocks which index the file are flushed to the storage device (operation S150).

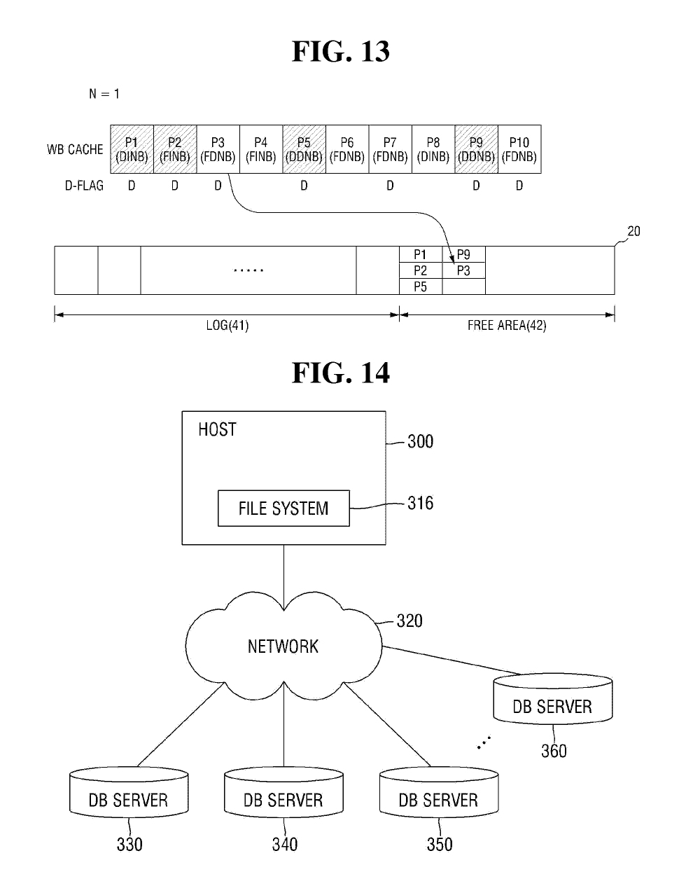

In the above example, the file system module 103 (see FIG. 2) may flush the third page P3 to the free area 42 of the storage device 20 as shown in FIG. 13. Here, since five initially requested pages have already been flushed to the storage device 20, the seventh page P07 and the tenth page P10 are not flushed to the storage device 20.

Metadata to be stored in the storage device 20 (see FIG. 1) is frequently updated by a host device 10. Of the metadata, the file direct node blocks 81 through 88 (see FIG. 6A) which directly indicate data blocks 70 (see FIG. 6A) are updated more frequently than the dentry direct node blocks 111 and 112 (see FIG. 6B) which directly indicate file blocks 100 (see FIG. 6B), and the dentry direct node blocks 111 and 112 (see FIG. 6B) are updated more frequently than the file indirect node blocks 91 through 95 (see FIG. 6A) which indicate the file direct node blocks 81 through 88 (see FIG. 6A) or the dentry indirect node block 121 (see FIG. 6B) which indicates the dentry direct node blocks 111 and 112 (see FIG. 6B).

Therefore, when the pages stored in the WB cache 104 (see FIG. 2) are flushed to the storage device 20 (see FIG. 1), the above characteristic may be taken into account. That is, flushing frequently updated pages to the storage device 20 (see FIG. 1) may be delayed as long as possible. In this case, unnecessary write operations due to page updates can be reduced, thereby improving the operating performance of the system.

FIG. 14 is a block diagram of a example of a computing system adopting one or more embodiments of the present inventive concept.

Referring to FIG. 14, a host server 300 is connected to a plurality of DB servers 330 through 360 through a network 320. In the host server 300, a file system 316 for managing data of the DB servers 330 through 360 may be installed. The file system 316 may be any one of the file systems described above with reference to FIGS. 1 through 13.

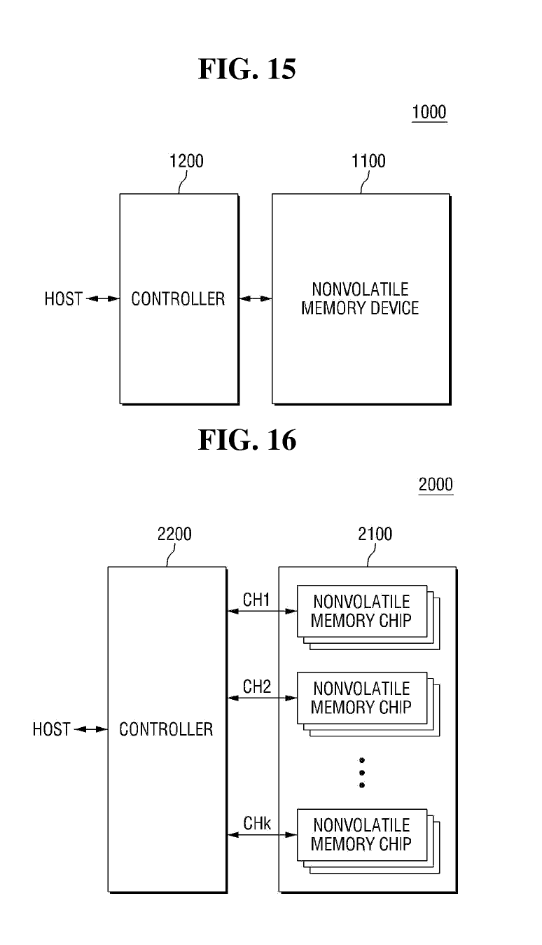

FIGS. 15 through 17 are block diagrams of specific other examples of computing systems adopting one or more embodiments of the present inventive concept.

Referring to FIG. 15, a storage system 1000 (corresponding to 20 in FIG. 1) may include a nonvolatile memory device 1100 and a controller 1200.

The super blocks 61 and 62, the CP area 63, the SIT 64, and the NAT 65 described above may be stored in the nonvolatile memory device 1100.

The controller 1200 is connected to a host and the nonvolatile memory device 1100. The controller 1200 is configured to access the nonvolatile memory device 1100 in response to a request from the host. For example, the controller 1200 may be configured to control read, write, erase and background operations of the nonvolatile memory device 1100. The controller 1200 may be configured to provide an interface between the nonvolatile memory device 1100 and the host. The controller 1200 may be configured to drive firmware for controlling the nonvolatile memory device 1100.

The controller 1200 further includes well-known components such as a random access memory (RAM), a processing unit, a host interface, and a memory interface. The RAM is used as at least one of an operation memory of the processing unit, a cache memory between the nonvolatile memory device 1100 and the host, and a buffer memory between the nonvolatile memory device 1100 and the host. The processing unit controls the overall operation of the controller 1200.

The controller 1200 and the nonvolatile memory device 1100 may be integrated into one semiconductor device. As an example, the controller 1200 and the nonvolatile memory device 1100 may be integrated into one semiconductor device to comprise a memory card. For example, the controller 1200 and the nonvolatile memory device 1100 may be integrated into one semiconductor device to comprise a memory card such as a personal computer (PC) card (e.g., Personal Computer Memory Card International Association (PCMCIA)), a compact flash card (CF), a smart media card (SM, SMC), a memory stick, a multimedia card (e.g., MMC, RS-MMC, MMCmicro), a SD card (e.g., SD, miniSD, microSD, SDHC), or a universal flash storage (UFS).

As another example, the controller 1200 and the nonvolatile memory device 1100 may be integrated into one semiconductor device to comprise a solid state drive (SSD). The SSD includes a storage device which stores data in a semiconductor memory. When the system 1000 is used as an SSD, the operation speed of the host connected to the system 1000 may increase significantly.

As another example, the system 1000 may be applicable to computers, ultra-mobile PCs (UMPCs), workstations, net-books, personal digital assistants (PDAs), portable computers, web tablets, wireless phones, mobile phones, smart phones, e-books, portable multimedia players (PMPs), portable game devices, navigation devices, black boxes, digital cameras, three-dimensional televisions, digital audio recorders, digital audio players, digital picture recorders, digital picture players, digital video recorders, digital video players, devices capable of transmitting/receiving information in wireless environments, one of various electronic devices constituting a home network, one of various electronic devices constituting a computer network, one of various electronic devices constituting a telematics network, a radio frequency identification (RFID) device, or one of various components constituting a computing system.

As another example, the nonvolatile memory device 1100 or the system 1000 may be packaged according to any of various packaging technologies. Examples of package technologies that may include the nonvolatile memory device 1100 or the system 1000 include Package on Package (PoP), Ball Grid Arrays (BGAs), Chip Scale Packages (CSPs), Plastic Leaded Chip Carrier (PLCC), Plastic Dual In-line Package (PDIP), Die in Waffle Pack, Die in Wafer Form, Chip On Board (COB), Ceramic Dual In-line Package (CERDIP), Plastic Metric Quad Flat Pack (MQFP), Thin Quad Flat Pack (TQFP), Small Outline Integrated Circuit (SOIC), Shrink Small Outline Package (SSOP), Thin Small Outline Package (TSOP), Thin Quad Flat Pack (TQFP), System In Package (SIP), Multi Chip Package (MCP), Wafer-level Fabricated Package (WFP), and Wafer-level Processed Stack Package (WSP).

Referring to FIG. 16, a system 2000 includes a nonvolatile memory device 2100 and a controller 2200. The nonvolatile memory device 2100 includes a plurality of nonvolatile memory chips. The nonvolatile memory chips form multiple memory chip groups. Each of the memory chip groups has a common channel for communication with the controller 2200. For example, in FIG. 16, the nonvolatile memory chips communicate with the controller 2200 through first through k^{th} channels CH1 through CHk.

In FIG. 16, a plurality of nonvolatile memory chips are connected to one channel. However, the system 2000 can be modified such that one nonvolatile memory chip is connected to one channel.

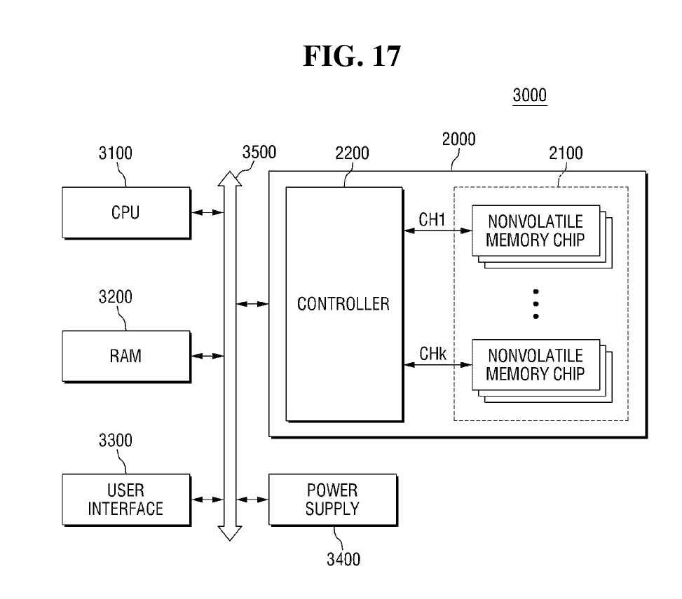

Referring to FIG. 17, a system 3000 includes a central processing unit (CPU) 3100, a RAM 3200, a user interface 3300, a power supply 3400, and the system 2000 of FIG. 16.

The system 2000 is electrically connected to the CPU 3100, the RAM 3200, the user interface 3300, and the power supply 3400 through a system bus 3500. Data, which are provided through the user interface 3300 or processed by the CPU 3100, are stored in the system 2000.

In FIG. 17, the nonvolatile memory device 2100 is connected to the system bus 3500 through the controller 2200. However, the nonvolatile memory device 2100 can also be connected directly to the system bus 3500.

In concluding the detailed description, those skilled in the art will appreciate that many variations and modifications can be made to the preferred embodiments without substantially departing from the principles of the present inventive concept. Therefore, the disclosed preferred embodiments of the inventive concept are used in a generic and descriptive sense only and not for purposes of limitation.

What is claimed is:

1. A computing system comprising:
a storage device; and
a host device configured to flush a plurality of pages to the storage device,
wherein the host device comprises:
a write-back (WB) cache configured to store the pages; and
a file system module configured to flush pages having first characteristics to the storage device from among the pages stored in the WB cache, and then flush pages having second characteristics which are different from the first characteristics to the storage device.

2. The computing system of claim 1, wherein the pages having the first characteristics comprise pages to be stored in the storage device as indirect node blocks.

3. The computing system of claim 2, wherein the indirect node blocks comprise file indirect node blocks which index a file and dentry indirect node blocks which index a directory.

4. The computing system of claim 2, wherein the pages having the second characteristics comprise pages to be stored in the storage device as direct node blocks.

5. The computing system of claim 4, wherein the direct node blocks comprise file direct node blocks which index the file and dentry direct node blocks which index the directory.

6. The computing system of claim 5, wherein the file system module flushes all pages to be stored in the storage device as the dentry direct node blocks which index the directory to the storage device from among the pages stored in the WB cache, and then flushes pages to be stored in the storage device as the file direct node blocks which index the file to the storage device.

7. The computing system of claim 1, wherein the host device further comprises a cache managing module setting a dirty flag for pages to be flushed to the storage device from among the pages stored in the WB cache.

8. The computing system of claim 7, wherein when a proportion of the pages set with the dirty flag among a total number of the pages stored in the WB cache is a predetermined value or greater, the file system module flushes the pages set with the dirty flag to the storage device.

9. The computing system of claim 1, wherein the storage device comprises a first area which is written in a random access manner and a second area which is written in a sequential access manner, wherein the pages having the first characteristics and the pages having the second characteristics are stored in the second area.

10. The computing system of claim 9, wherein in the storage device, a physical address of the first area precedes a physical address of the second area.

11. The computing system of claim 1, wherein metadata about a file or a directory is stored in each of the pages.

12. The computing system of claim 1, wherein the storage device comprises a static solid disk (SSD).

13. A host device comprising:
a storage interface configured to communicate with a storage device;
a write-back (WB) cache memory configured to store a plurality of pages; and
a file system module configured to flush pages having first characteristics to the storage device via the storage interface from among the plurality of pages stored in the WB cache, and then flush pages having second characteristics which are different from the first characteristics to the storage device via the storage interface among the plurality of pages.

14. The host device of claim 13, wherein the file system module is configure to flush N pages among the plurality of pages stored in the cache memory, where N is a natural number, and
wherein when the number of pages among the plurality of pages having the first characteristic is L, where L is a natural number and N>L, the file system module is configured to first flush the L pages having the first characteristic, and then flush (N-L) pages having the second characteristic.

15. The host device of claim 13, wherein the pages having the first characteristics comprise pages to be stored in the storage device as indirect node blocks, and the page having the second characteristics comprise pages to be stored in the storage device as direct node blocks.

16. The host device of claim 13, wherein metadata about a file or a directory is stored in each of the pages.

17. A method of managing data in a computing system, the method comprising:
providing a plurality of pages;
flushing N pages to a storage device from among the pages, where N is a natural number,
wherein the flushing of the N pages to the storage device comprises:
flushing the N pages having first characteristics to the storage device when the number of pages having the first characteristics from among the pages is M, where M is a natural number, and M≧N; and
flushing L pages having the first characteristics to the storage device when the number of pages having the first characteristics from among the pages is L, and then flushing P pages having second characteristics which are different from the first characteristics to the storage device, wherein L and P are natural numbers, L<N, and P=N−L.

18. The method of claim 17, wherein the pages having the first characteristics comprise pages to be stored in the storage device as node blocks which comprise node pointers.

19. The method of claim 17, wherein the pages having the second characteristics comprise pages to be stored in the storage device as node blocks which comprise data pointers.

20. The method of claim 17, wherein the pages comprise pages set with a dirty flag indicating that the pages are to be flushed to the storage device and pages not set with the dirty flag, and the flushing of the N pages to the storage device comprises flushing N pages set with the dirty flag to the storage device.
